(19) United States
(12) Patent Application Publication
(10) Pub. No.: US 2010/0088014 A1
(43) Pub. Date: Apr. 8, 2010

(54) COMPUTER PROCESS AND PROGRAM PRODUCT FOR GENERATING AN ARCHAEOLOGICAL MAP WHICH CAN BE CONSULTED BY MEANS OF NAVIGATION

(76) Inventors: Andrea Carandini, Roma (IT); Paolo Carafa, Roma (IT)

Correspondence Address: Steinfl & Bruno, 301 N Lake Ave Ste 810, Pasadena, CA, 91101, US

(21) Appl. No.: 12/444,835

(22) PCT Filed: Oct. 1, 2007
(86) PCT No.: PCT/IB2007/054502

§ 371 Date: Nov. 4, 2009

(30) Foreign Application Priority Data
Oct. 13, 2006 (IT) RM2006A000552

(51) Int. Cl. G01C 21/00; G06F 17/30; G06F 17/50; G06F 3/048; G09G 5/00

(52) U.S. Cl. 701/200; 707/722; 703/1; 715/781; 345/632; 707/E17.018; 707/E17.045; 707/E17.027

(57) ABSTRACT

A computer process and tool (I_Sys), or information system, are described which permit electronically archiving information related to archaeological discoveries, in order to allow interested parties to easily consult such information and to allow safer, efficient and systematic preservation of such information. In particular, an efficient archaeological information system is described for the analysis, reconstruction, archiving and knowledge of landscapes, structures, and objects which are representations of antiquity.

The present invention regards the technical sector of generating and displaying electronic maps, and in particular regards a computer process and program product for generating and displaying an electronic archaeological map which can be consulted by means of navigation.

The need is heard for making a computer tool, or information system which permits archiving in an electronic manner information related to archaeological discoveries, in order to allow interested parties to easily consult such information and to allow a safer, efficient and systematic conservation of such information. In particular, the need is heard to provide an efficient archaeological information system for the analysis, reconstruction, archiving and knowledge of landscapes, structures, and objects which are representations of antiquity.

Currently, several computer tools are known which permit displaying web pages so to show very limited portions of archaeological maps and in which the displayed information is present in static or nearly static manner. Among these, the most common computer tools are simple applications, such to provide a digital image on video, image corresponding to a digitalisation of a generally limited portion of a paper archaeological map, such as for example an archaeological chart, on which possibly the archaeological findings are highlighted by means of suitable graphic symbols. The graphic symbols can be possibly associated with a key, or alternatively such graphical symbols correspond to hypertext connections to pages containing further information or photographic images related to the archaeological discoveries.

The above-indicated display methods of the prior art, which for example can be convenient for displaying an archaeological map of a site of very limited-territorial extension, are incapable of generating archaeological maps which refer to extended geographical areas and/or areas with a high density of archaeological findings, and moreover make the archiving of the archaeological information, both text and graphics, particularly inefficient, little flexible and complicated. Moreover, such methods have a very limited possibility of tracing the evolution which a same archaeological discovery has undergone over time.

The object of the present invention is that of providing a process for generating and displaying an archaeological map which can be consulted by means of navigation which is capable of satisfying the abovementioned need, overcoming the drawbacks described with reference to the prior art.

This object is attained by means of a display process as defined in general in the attached claim 1. Advantageous embodiments of a process according to the present invention are defined in the attached dependent claims.

Another object of the present invention is that of providing a computer system and a computer program product which allows displaying an archaeological map which can be consulted by means of navigation. Such object is attained through a computer system and computer program product as defined in general respectively in claims 13 and 15.

Further characteristics and advantages of the present invention will be clear from the following description of non-limiting embodiments thereof, in which:

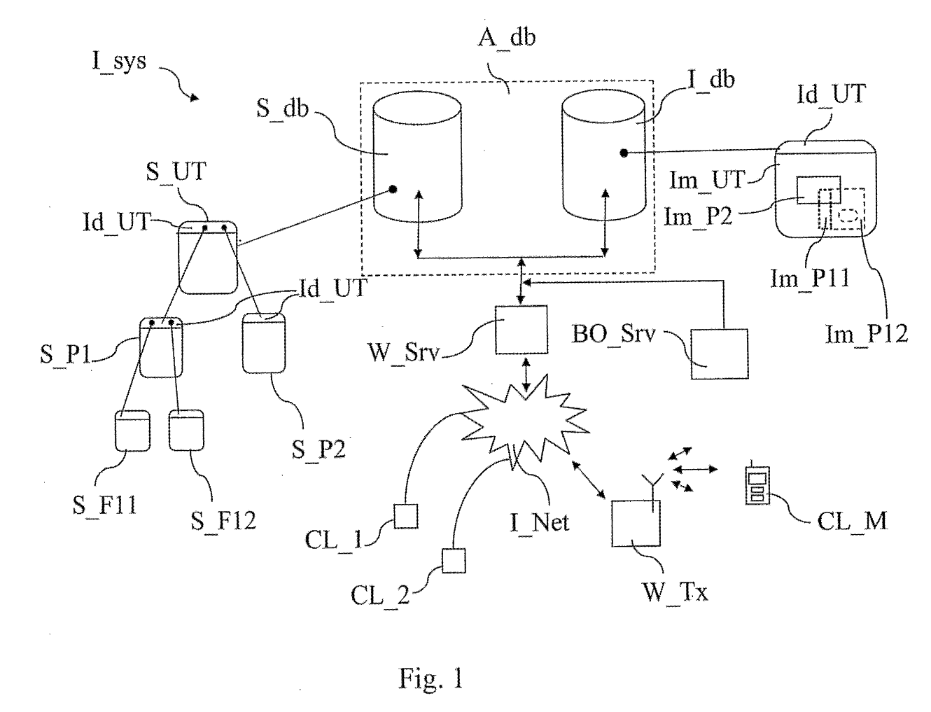

FIG. 1 schematically shows the architecture of a particularly preferred embodiment of a computer system by means of which a process according to the invention can be actuated;

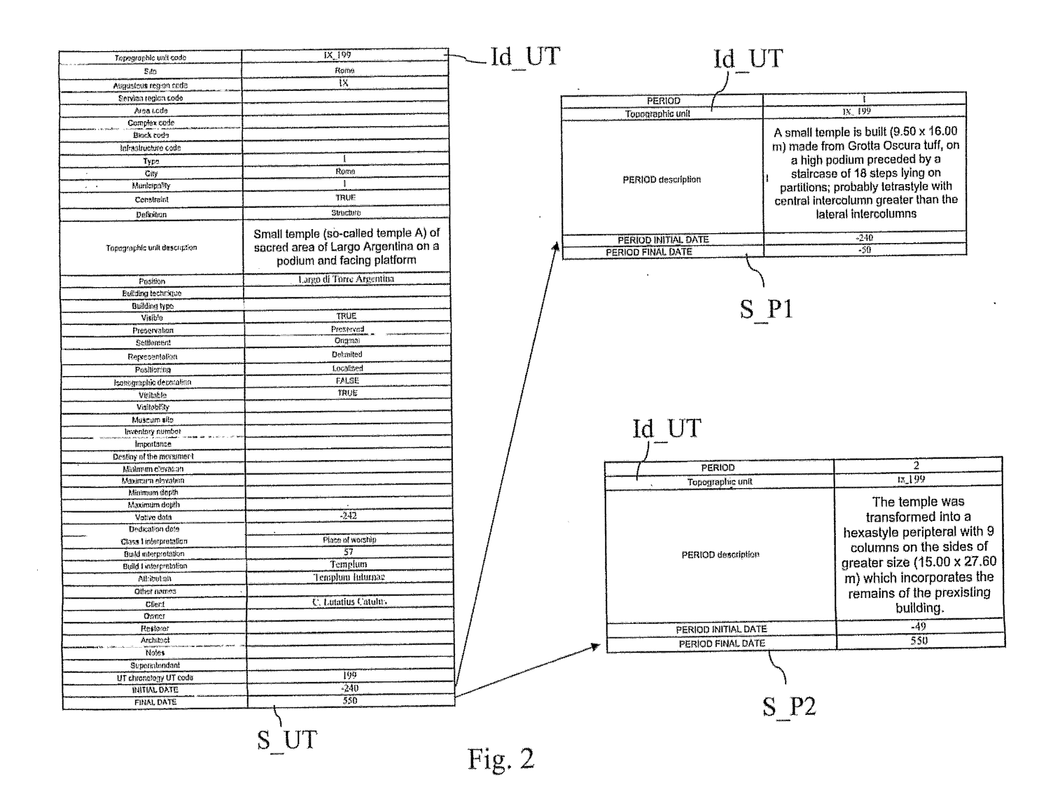

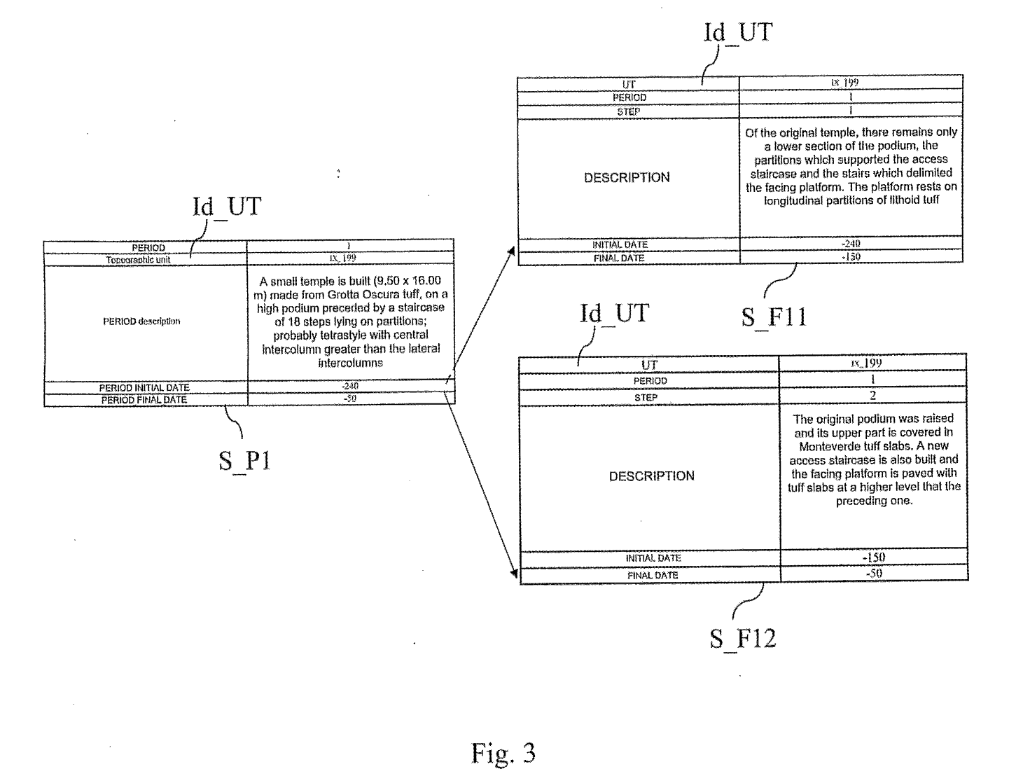

FIGS. 2 and 3 show several examples of files storable in a relational database of the computer system of FIG. 1 for storing descriptive/historical information of a topographic archaeological unit; and

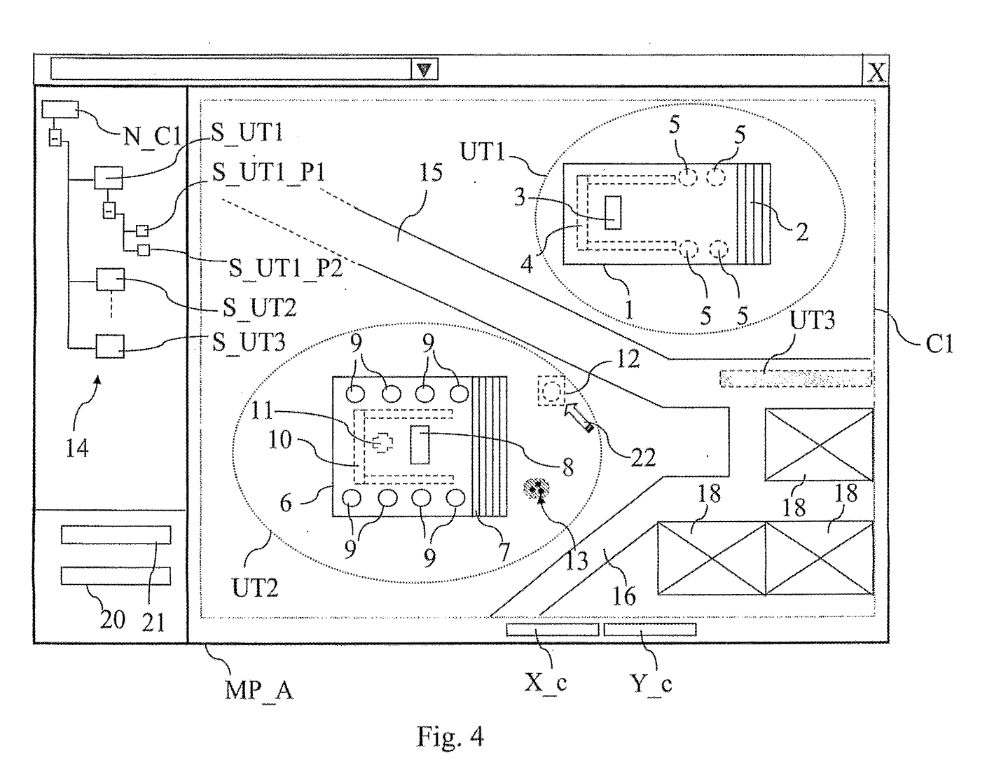

FIG. 4 shows a schematic and exemplifying view of a possible archaeological map which can be generated and displayed through a process in accordance with the present invention.

In the figures, equivalent or similar elements will be indicated with the same reference numbers.

With reference to FIG. 1, a particularly preferred embodiment is described of a computer system, indicated with I_sys in its entirety, for actuating a process in accordance with the present invention.

The computer system 1 includes a databank A_db adapted to permit the storage and consultation of data, both textual and graphic, related to archaeological discoveries. In particular, the databank A_db includes a relational database S_db adapted to store data or textual information related to archaeological discoveries according to a hierarchical organization making reference to topographic unit files, each unit corresponding to a respective element or entity of the archaeological landscape.

In practice, a topographic unit corresponds to an element of the archaeological landscape which represents a discovery/monument discernable as a single unit, such as for example: a temple, a theatre, a forum, a portico, a basilica, a funerary monument, a home, a workshop, a bridge, a sanctuary, a tower, a fountain, a well, etc.

The relational database S_db is both a hardware and software entity, and preferably on the software level it is a database of Microsoft™ SQL Server type.

The relational database S_db permits archiving the textual information related to archaeological findings in suitable data structures, each adapted to store a respective topographic unit file S_UT. Each data structure includes data fields adapted to store textual data corresponding to historical and/or descriptive information of a respective topographic unit and includes at least one data field adapted to store an identification code Id_UT of such topographic unit. Such identification code is preferably an alphanumeric code and represents the primary key of all search paths inside the relational database S_db with regard to the topographic unit to which this is associated.

The identification code Id_UT can be a code which serves to identify a topographic unit in an absolute manner or relative manner, and preferably it is a simple numeric code (for example “1” or “27”, etc.). For the archiving of information regarding archaeological discoveries of very large zones, or zones with a very high density of topographic units (for example the city of Rome), it is conveniently possible to subdivide the zone into several regions and to “reuse” identification codes between the different regions, also including in the topographic unit file a data field adapted to store a region identification code.

For example, wishing to catalogue the information related to the archaeological findings of the city (or site) of Rome, which has a considerable territorial extension and in which a high number of topographic units can be identified, for practical reasons it has been conveniently thought to subdivide the area of the city into fourteen regions (or “regiones”) corresponding to the so-called “Regions under Augustus” respectively indicated, according to Latin numeration, from: I to XIV. To each of the topographic units, an identification code Id_UT was then assigned, adapted to unequivocally identify a topographic unit inside the region to which it belongs. In such case, a data field was also provided in the topographic unit file S_UT, field adapted to contain an identification code of the region to which it belongs. Alternatively, it is possible to ensure that the identification code Id_UT of a topographic unit is a complex code, including a first identifying part of the region and a second part which allows unequivocally identifying the topographic unit inside the region and a second part which allows unequivocally identifying the topographic unit inside the region. In this case, the identification code Id_UT could for example be a string of the type “RR_nnn”, in which “RR” represents identifying characters or digits of the region (for example RR=IX) and “nnn” represents identifying characters or digits of the topographic unit (for example nnn=199).

In particularly preferred embodiment, each file S_UT associated with a topographic unit moreover allows storing, in addition to historical/descriptive information, also the following data (if available): complex, block, area, site, which represent geographical/archaeological entities which together with the regions form groupings of topographic units at an increasing aggregation level, in the order specified below: topographic unit, complex, block, area, region, site.

In a particularly advantageous embodiment, the relational database S_db also includes files, not shown in FIG. 1, called “source files” and containing specific bibliographical, literary/epigraphic or archival information hierarchically connected to a respective topographic unit file S_UT through an identification code Id_UT of the topographic unit.

In a particularly advantageous embodiment, if a topographic unit has undergone an evolution (intended in general as a modification) passing from at least a first chronological period in which the unit had a first topographic configuration to a second chronological period in which such unit had a second topographical configuration, the relational, database S_db allows storing, for these topographic units, further files S_P1 and S_P2, known as “period files”, adapted to store textual data corresponding to historical and/or descriptive information of said topographic units respectively with regard to the first and second chronologic period. In any case, the storage will be provided for of a topographic unit file S_UT containing textual/descriptive information common to the first and second chronological period and containing the identification code Id_UT of the topographic unit. Each of the period files S_P1 and S_P2 will include the identification code Id_UT of the topographic unit and a period identification code (for example period “1” or “2”).

From here on in the present description, without introducing any limitation, reference will be made to the case in which the topographic unit identification code Id_UT is a complex code, for example in the form of a string of “RR_nnn” type, in which “RR” represents identification characters or digits of the region and “nnn” represents identification digits of the topographic unit.

In FIG. 2, several examples are shown of files related to a real topographic unit (Id_UT=IX_{—}199) discovered in the territory of the city of Rome and in particular in the region “IX”. In particular, in FIG. 2 a topographic unit file S_UT is shown together with two files (or sub-files) of period s_P1, S_P2 respectively corresponding with two consecutive chronologic periods (called “period 1” and “period 2”) during which the topographic unit has undergone a modification from a first topographic configuration to a second topographic configuration. As can be noted, all of the files S_UT, S_P1, S_P2 bear the same identification code Id_UT=IX_{—}199 of the topographic unit to which the topographic unit file S_UT refers.

As shown in the scheme of FIG. 1, in a particularly preferred embodiment it is also possible to take into account possible evolutions/modifications sustained by a topographic unit during one same chronological period, for example subdividing the period into several phases at a logic level and providing, in the relational database S_db, further files (or sub-files) S_F11, S_F12, called “phase files”, to associate with one same period file, in the figure example with the file S_P1. In FIG. 3, particular examples are shown of phase files S_F11 and S_F12, associated with “period 1” of the topographic unit whose identification code is IX_{—}199. As can be noted, the phase files S_F11, S_F12 also bear the same identification code Id_UT=IX_{—}199 of the topographic unit to which the topographic unit file S_UT refers.

Without continuing to describe the further subdivisions in detail, it is noted that it is possible, by providing for additional files (or sub-files) in the database S_db, hierarchically connected to a topographic unit file, or to period files or phases thereof, to advantageously keep track of single actions in the database S_db (whose trace on a topographic unit or part thereof is called a stratigraphic unit), executed by man over time on a topographic unit and/or describe single physical objects which compose such topographic unit or which have been discovered near the latter.

Advantageously, the databank A_db of the computer system 1 also includes an image archive I_db intended to store, for each topographic unit, at least one vector, image Im_UT graphically representative of said topographic unit and georeferenced in a reference cartographic system. Each vector image Im_UT is associated with the identification code Id_UT of the topographic unit, of which such image Im_UT constitutes its graphical, representation. For example, the vector images are three-dimensional representations or plan representations of topographic units.

In a particularly advantageous embodiment, if a topographic unit has sustained an evolution from at least a first chronological period in which the unit had a first topographic configuration to a second chronological period in which such unit had a second topographic configuration, the image archive I_db allows storing a first vector image Im_P11, Im_P12 and a second vector image Im_P2 graphically representative of said first and said second topographic configuration, respectively, and associating, with each of said images, the identification code of the first period and the identification code of the second period, respectively. In turn, the first image Im_P11, Im_P12 can for example be formed by two or more images Im_P11, Im_P12 corresponding with topographic configurations graphically representative of a same topographic unit in two or more separate phases of a same period. Moreover, by providing, in the relational database S_db, sub-files of objects, of stratigraphic units hierarchically organised and related to respective topographic units, or to periods or phases thereof, it is possible to provide respective graphic instances (if available) in the image archive I_db.

In a particularly preferred embodiment, the vector images stored are plan vector representations made by means of a CAD (Computer Aided Design) program, in which graphical representations (or topographical configurations) of a same topographic unit related to different periods or phases are made by means of separate layers of a same image or CAD file, each layer being preferable associated with a respective colour. Preferably, the plan vector representations are obtained from perimetrical surveys of topographic units.

Preferably, the identification codes of the topographic unit, periods and phases are associated with the images by using suitable names for the different layers. For example, a layer identified by the following string “IX_{—}199_{—}1_{—}2” could graphically represent the topographic unit “199” of the region “IX” in the configuration that such unit had in phase “2” of the period “1”. Advantageously, it is also possible to associate with the image archive I_db, and preferably with the names of the layers, possible further alphanumeric and/or positional codes which are in practice indicative of the visibility state (for example: visible=“V”, not visible=“W”), preservation state (for example: preserved=“C”, not preserved=“NC”), and localisation state (for example: original localisation=“o”, repositioned=“r”) of the topographic unit (or of the portion thereof) represented in such images or layers. For example, a layer identified by the following string “IX_{—}199_{—}1_{—}2_NV_C_o” could graphically represent the topographic unit “199” of the region “IX” in the configuration that such unit had in phase “2” of the period “1” and specify that such configuration is not visible (attributed with “NV”) but is preserved (attributed with “C”) and which is physically arranged in its original localisation (attributed with “o”). A non-visible but preserved topographic configuration is had for example when the topographic unit, or part thereof, has been incorporated in subsequent constructions (buildings, roads) which prevent its access and/or visibility.

As shown in FIG. 1, the computer system 1 moreover includes a processing device W_Srv (intended as both software and hardware entity), preferably in the form of a server, which allows access to the data contained in the databank A_dB. Preferably, the processing device W_Srv is a Web application server accessible by means of a telecommunications network I_Net, such as for example Internet. Such server W_Srv is for example capable of processing query requests transmitted on the network I_Net from:
fixed communication terminals CL_1, CL2 such as for example personal computers, “totems”, video-stations, set-top-boxes and the like; and/or
movable communication terminals CL_M, such as for example UMTS, satellite and other like terminals, in bi-directional connection with a radio station W_Tx connected with the network I_Net.

Advantageously, the server W_Serv allows, in response to query requests, generating a georeferenced archaeological map of a geographic zone (for example of a site) by means of an application program based on the use of GIS (Geographic Information System) technology, preferably accessible in the form of a portal. The georeferenced vector images of the topographic units belonging to said geographic zone or to portions thereof are displayed in a web page. Such application program, for example developed by means of the tool Geo-Media WEBMAP™, advantageously allows consultation by means of navigation of the archaeological map (for example, by means of navigation instruments such as “PAN”, i.e. the movement of the displayed zone, or “Zoom”, i.e. the scaling of the displayed territory portion) and is such, by integrating the data present in the relational database S_dB and the data present in the image archive I_dB, to provide, on user request and according to different detail levels, the information contained inside the topographic unit files (and in possible period, phase and other sub-files). For example, the display of such information can occur by means of tools such as:

the so-called “tool tip”, which permits displaying small portions of textual information at the same time as the cursor of a mouse, or a pointer, passes over sensitive zones of the displayed map;
the so-called “hot spot”, which permits associating actions with the click of a mouse on specific displayed elements, which have been made sensitive to the click;
the so-called “pop-ups”, which allow the opening of sub-windows, automatically or in response to user actions.

In a particularly preferred embodiment, the graphic application program allows displaying on the screen of a user terminal both the archaeological map and a tree structure (for example, on the left of the displayed page) with expandable ramifications at different detail levels and such to display at least part of the information contained in the relational database A_dB in parallel with the display of the vector images, the tree structure being such to graphically show the hierarchical relations between the different entities (topographic unit files, period files, phase files, source files, object files, etc.) stored in the relational database S_db.

In a particularly advantageous embodiment, the graphic application program permits displaying the graphical representation of a topographic unit by showing the different graphical representations of the topographic unit, corresponding to different chronological periods (or phases thereof) of the unit, superimposed and preferably by means of different graphical styles (for example, by means of different colours), also permitting a user to select graphical representations for the display corresponding with specific periods, excluding from the display the graphical representations of the remaining periods (or phases thereof).

Conveniently, by using attributes associated with the images of the image archive I_db, the graphic application program also allows selecting topographic units or topographic configurations thereof for the “visible” or “non-visible” display, advantageously permitting the video generation of an archaeological map of the visible archaeological discoveries and an archaeological map of the non-visible discoveries, or alternatively generating an archaeological map in which all that which is visible is graphically represented so to be able to be separate from all that which is not visible (for example, representing the different vector images by means of different colours).

In a particularly preferred embodiment, the graphic application program is such to show the archaeological map generated by displaying the vector images superimposed on a photo area of the geographic zone corresponding with the displayed map and/or basic cartographic map (in raster or vector format) of said geographic zone. In such a manner, a user, for example equipped with a mobile terminal with a satellite localisation device, can advantageously visit a site, observing on the terminal display the position of the site in the basic cartographic map and/or in the archaeological map.

In a particularly preferred embodiment, the application program allows providing, in addition to the archaeological map, information of popular/tourist character which allows transforming or integrating the information archived in the system, due to particular communication needs. To such end, publication can be provided for, for example by means of the application program, of the following information:
three-dimensional static or interactive reconstructions;
map of the public transport lines, as preferential, organised itinerary for the visit to monuments, museums and archaeological areas;
map of the tourist infrastructures connected or connectable to possible visit itineraries;
a set of iconographic sources which illustrate particular aspects of daily life in the past in an archaeological area, in relation with archaeological discoveries graphically represented in the map;
films of preferably short duration (1-2 minutes).

Returning to the scheme of FIG. 1, the computer system 1 moreover preferably includes a so-called back office system BO_Srv, which allows authorised experts to manage (update, modify etc.), also from a distance, the databank A_db. The back-office BO_Srv must be intended as a software and hardware entity and preferably at the software level it is an application program which by means of appropriate masks allows an operator to modify the data archived in the databank A_dB. Preferably, such application program provides masks of Microsoft™ Access type, and more preferably it is made by means of the tool Geo-Media Professional™.

In FIG. 4, a particular example is schematically shown of archaeological map MP_A, generated and displayed by means of a system and method in accordance with the present invention.

In particular, a web page is represented in FIG. 4 in which an archaeological map MP_A related to a geographic zone is displayed, including a monumental complex C1, such as for example an ancient sacred area, constituted by three topographical units UT1, UT2, UT3. In the example, the topographic units UT1 and UT2 are in practice visible remains of temples, while the topographic unit UT3 is the remains of a ancient street pavement. The archaeological map MP_A also shows a contemporary archaeological map, of which two roads 15 and 16 and some buildings 18 are visible in FIG. 4.

In FIG. 4, the topographic unit UT3 is shown by means of a vector image represented with a different graphic character (sloped hatch marks) with respect to that used for the representation of the vector images of the topographic units UT1 and UT2, since in the example it represents a topographic unit which being covered by a recent road pavement (street 15) is no longer visible.

The topographic unit UT1, or rather its vector representation in the map MP_A, is formed by a superimposition of two vector images (of which one is represented by means of continuous lines and the other by means of dashed lines) corresponding with two separate topographic configurations of the unit UT1 in two separate historical periods. In practice, through map MP_A it can be observed that the topographic unit UT1 in a first historical period was formed by a base 4, a staircase 2 and an altar 3. As shown by map MP_A, in a subsequent historical period, the following were added: a cella 4 and four columns 5 to form a pronaos in from of the cella 4. In the relational database S_dB files S_UT1, S_UT2, S_UT3 are provided for which respectively contain textual/descriptive information of the three topographic units UT1, UT2, UT3. A tree diagram 14 on the left of the page shows the hierarchical relations between the files and in particular shows how such files belong to a same complex C1, whose name N_C1 is for example displayed at the root of the tree diagram 14. The tree diagram 14 moreover shows some textual information contained in the files S_UT1, S_UT2 and S_UT3 (for example the identification code of the topographic units, their current name, a summarised description). As seen from the diagram 14, for the topographic unit UT1, in addition to the topographic unit file S_UT1, two period sub-files S_UT1_P1 and S_UT1_P2 are provided for.

Also the topographic unit UT2, or rather its graphic vector representation, is formed by the superimposition of two vector images (of which one is represented by continuous lines and the other by dashed lines) respectively representative of the topographic configuration of the unit UT2 in a first and second historical period. In practice, through the map MP_A it can be observed that the topographic unit UT2 in a first historic period was formed by a base 6, a staircase 7 and an altar 8. As shown by the map MP_A, the following were added in a subsequent historical period: a cella 10, a colonnade 9, a statue 11 and a well 12. Several non-visible votive objects 13 (marked in the circle) also date from the second historical period of the unit UT2; they are not visible since they are currently preserved in a museum.

Finally, as shown in FIG. 4 in the web page, masks can also be provided for, for searching in the relational database, along with filters 21 (for example “show visible/show non-visible”, or “add/remove basic cartographic map”), or indicators of positional coordinates X_c, Y_c adapted to display the positional coordinates of a cursor 22.

As can be appreciated from that described above, it is evident that a method and computer system according to the invention allows fully meeting the needs indicated in the introductive part of the present invention.

It is moreover observed that the process and system in accordance with the present invention in addition to providing a useful tool to scholars or to enthusiasts, are capable of automatically providing a so-called “map of the archaeological risk” of a geographic area, for example advantageously permitting operators to carefully plan in the design of urban spaces.

Of course, a man skilled in the art, in order to satisfy specific and contingent needs, can make numerous modifications and variants to the particular embodiments of the above-described invention, modifications and variants which are all moreover contained in the protective scope as defined by the following claims.

1. A process for generating and displaying an electronic archaeological map, including the operations of:
storing, in a relational database, data related to archaeological findings, organising the data in topographic unit files, corresponding to respective elements of the archaeological landscape, each file being stored in a respective data structure including data fields adapted to store historical and/or descriptive textual data of said topographic unit and a topographic unit identification code;
for each topographic unit, storing, in an image archive, at least one vector image, georeferenced in a reference cartographic system, adapted to graphically represent said topographic unit, associating said vector image with the identification code of said topographic unit;
generating, by way of a graphic application program GIS, a georeferenced map of a geographic zone, displaying the georeferenced vector images of the topographic units belonging to said geographic zone, said map being a map which can be consulted by way of navigation, the graphic program being such to make available, on request, said descriptive historical textual data of said topographic units.

2. The process according to claim 1, wherein at least one of said topographic units has undergone an historical evolution, passing from a first topographic configuration in one chronological period to a second topographic configuration in a second chronological period, and wherein:
the step of storing in the relational database includes the operations of:
storing, in the relational database, a first file including historical and/or descriptive textual data of said topographic unit common to said first and said second chronological period and including an identification code of said topographic unit;
storing, in the relational database, a second file including descriptive and/or historical data of said topographic unit in said first historical period and including said identification code of said topographic unit and an identification code of said first period;
storing, in the relational database, a third file including historical and/or descriptive information of said topographic unit in said second chronological period and including said identification code of said topographic unit and an identification code of said second period;
and wherein said step of storing at least one georeferenced vector image includes the operations of storing, in the image archive, a first and a second vector image, respectively representative of said first and said second topographic configuration, and respectively associating with these the identification code of said topographic unit and the identification code of said first period and the identification code of said topographic unit and the identification code of said second period.

3. The process according to claim 2, wherein the operation of generating the georeferenced map is such to display the first and the second vector image superimposed.

4. The process according to claim 3, wherein the first and the second vector image are displayed with graphic styles which are different from each other.

5. The process according to claim 1, wherein the first and the second vector image correspond to two separate layers of a same image processed by means of a CAD program and respectively corresponding to a georeferenced perimetrical relief of said first and said second topographic configuration.

6. The process according to claim 1, wherein the operation of generating the georeferenced archaeological map is such to display, with different graphic styles, topographic units or parts thereof which are visible or non-visible.

7. The process according to claim 6, wherein the graphic application program permits a user to select, for the display, topographic units, or parts thereof, which are visible or non-visible.

8. The process according to claim 1, wherein said graphic application program is such to show said archaeological map superimposed on an area photo of said geographic zone.

9. The process according to claim 1, wherein the graphic application program is such to show said archaeological map superimposed on a basic cartographic map of said geographic zone.

10. The process according to claim 1, wherein said geographic zone is a city and wherein the graphic application program is such to show said archaeological map superimposed on a map of said city.

11. The process according to claim 1, further including a step of storing, in said relational database, information regarding bibliographical, literary/epigraphic and archival sources, the information being organized in respective “source” files and stored in suitable data structures, each “source” file being associated with a respective topographic unit through the identification code of said topographic unit.

12. The process according to claim 1, further including a step of storing, in said relational database, information relating to chronological periods, to historical phases of topographic units, objects discovered in such topographic units or actions thereon executed according to a hierarchical organisation in files or sub-files of different types, each related in the relational database to a respective topographic unit file by way of the respective identification code of said file, also providing for the storing of respective graphic instances, if available, in the image archive.

13. A computer system including a relational database and an image archive and processing means for actuation of the process according to claim 1.

14. The computer system according to claim 13, further including a remote back office system for updating said relational database and said image archive.

15. A computer program product including program code lines directly loadable in the memory of at least one processor and comprising software code portions for actuating the process according to claim 1.

16. A method of using the process of claim 1, for the production of a map of the archaeological risk intended for urban space planning and design activities.
